(19) United States
(12) Patent Application Publication
(10) Pub. No.: US 2005/0055991 A1
(43) Pub. Date: Mar. 17, 2005

(54) Air purification and physiological metabolism promoting health material

(76) Inventor: Yi-Ting Nancy Hsu, City Taoyuan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/661,623

(22) Filed: Sep. 15, 2003

(51) Int. Cl. B01D 46/00

(52) U.S. Cl. 55/524

(57) ABSTRACT

An air purification and physiological metabolism promoting health material consisting of a naturally radiating rare earth element capable of emitting ions that is finely pulverized and attached at an appropriate density to the surface of a synthetic or a natural base material. Since the finely pulverized, naturally radiating rare earth element is in an unencapsulated, exposed state, the ions emitted are directly released into the air or absorbed by the body such that physiological metabolism and air purification is provided for at even greater promotional effectiveness.

### BACKGROUND OF THE INVENTION

1) Field of the Invention

The invention here relates to health materials, specifically an air purification and physiological metabolism promoting health material.

2) Description of the Prior Art

Numerous types of materials are conventionally utilized in the operation of health appliances. For example, infrared radiating ceramic magnets or magnetic line materials are utilized in the manufacturing of health equipment materials or products.

Of course, there are also health equipment that utilize ions as a health material; naturally radioactive rare earth element minerals capable of generating positive ions are often used to produce various types of health equipment and materials, wherein the said naturally radioactive rare earth element minerals are generally treated such that the said naturally radioactive rare earth element minerals are processed into a fine powder which is dissolved and thoroughly blended in resin, following which the resultant material is fabricated into the required shape by a conventional vacuum forming machine or injection molding machine. This approach to shaping health material for positive ion emission is currently is the most widespread one known.

However, in actual practice, the shaping of the naturally radioactive rare earth element mineral mixed with resin by the said vacuum forming machine or injection molding machine has its drawbacks because the ion emission energy and finely pulverized naturally radiating rare earth element mineral are encapsulated in resin such that the emission is obstructed by the resin and the expected results cannot be achieved.

### SUMMARY OF THE INVENTION

The primary objective of the invention herein is to provide an air purification and physiological metabolism promoting health material, wherein a finely pulverized, naturally radiating rare earth element capable of emitting ions is attached at an appropriate density to the surface of a synthetic or a natural base material; the finely pulverized, naturally radiating rare earth element is in an unencapsulated exposed state, enabling ion emission capacity to reach the maximum limits for direct release into the air or absorbtion by the body such that air purification and physiological metabolism is provided for at even greater promotional effectiveness.

Another objective of the invention herein is to provide an air purification and physiological metabolism promoting health material that is of a simple arrangement, easy to utilize, and convenient, the naturally radiating rare earth element of which has a large, exposed surface area that is capable of releasing large volumes of emitted ions into the air or directly to the body for absorption, thereby achieving predictable air purification and the promotion of physiological metabolism and, furthermore, an air purification and physiological metabolism promoting health material that is not currently available.

### BRIEF DESCRIPTION OF THE DRAWINGS

FIG. 1 is a cross-sectional drawing of a finely pulverized, naturally radioactive rare earth element.

### DETAILED DESCRIPTION OF THE INVENTION

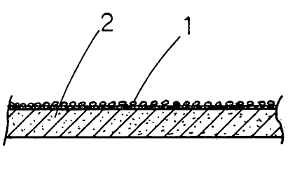

Referring to FIG. 1, the air purification and physiological metabolism promoting health material of the invention herein is comprised of a finely pulverized, naturally radioactive rare earth element 1 in an exposed state that is attached to the surface of a synthetic or a natural base material 2, wherein the said naturally radioactive rare earth element mineral 1 is any of the 15 elements listed under atomic numbers 57 to 71: lanthanum, cerium, praseodymium, neodymium, promethium, samarium, europium, gadolinium, terbium, dysprosium, holmium, erbium, thulium, ytterbium, and lutetium as well as scandium (atomic number 21) and yttrium (atomic number 39), which are all capable in their natural state of emitting positive ions for air purification and promoting physiological metabolism; the said naturally radioactive rare earth element 1 is processed into a fine powder consisting of equal diameter particulate that is affixed to the base material 2, the exact manner depending on the actual application, though an optimal thickness is typically 0.1 mm˜100 μm.

The said base material 1 can be of natural or synthetic construction such as a relatively thin, flat natural fiber, synthetic fiber, synthetic resin, or metal sheet-like material, or a composite planar member constructed of synthetic resin and natural wood board, the material and shape thereof virtually unlimited.

The said finely pulverized, naturally radioactive rare earth element 1 is disposed onto the base material 2 through an interlaced, adhesive, or other means; however, regardless of the particular approach, the said finely pulverized, naturally radioactive rare earth element 1 can be expected to become effectively emplaced, with the base material 2 providing for the attachment remaining unaffected by functioning as a base and retaining its original characteristics and capability.

Additionally, after each said type of naturally radioactive rare earth element mineral 1 is processed into a fine powder, they are blended for use as single element or combination of two or more elements; the density at which they are attached to the surface of the base material 2 depending on the magnitude of positive ions generation required as determined by their average distribution on the base material 2, thereby meeting anticipated utilization performance.

In other words, the said naturally radioactive rare earth element mineral is capable of positive ion emission and it is also generally well-known that the said positive ions possess air purifying and physiological metabolic stimulating effects. With the arrangement of the invention herein, the said naturally radioactive rare earth element 1 is affixed to the surface of the base material 2 in an unencapsulated state, thereby allowing the exposure of the rare earth element to the air in a natural state, actively releasing positive ions; the surface area of the said rare earth element 1 can be enlarged such that the said average positive ion emission capacity reaches the maximum limit, enabling the ions released to be emitted into the air or directly into the body for absorption, thereby purifying air and promoting physiological metabolism at higher efficiency.

Embodiments of the said air purification and physiological metabolism promoting health material of the invention herein include the following examples: the finely pulverized, rare earth element of the invention herein can be woven into or glued onto the interior surface of an antiseptic mask (i.e., disposed along the nostril area inside the mask), the normal act of breathing enabling the inhalation of large volumes of air laden with positive ions into the body that offsets fatigue, keeps air clean and refreshing, and improves labored breathing. Or, the finely pulverized, rare earth element of the invention herein can be pasted in a facial mold (via a vegetable extract liquid paste), with the said rare earth element directly permeating the fiber perforations of the facial mold such that when the facial mold is situated on the face and the positive ions emitted are absorbed into the pores of the face along with the various nourishing ingredients also held by the facial mold itself that effectively reinvigorate the metabolism of the face and grooms it, thereby providing more concrete and additional capability. Or, the finely pulverized, rare earth element of the invention herein can be glued or interlaced for use onto necklaces, rings, earrings, cup lids, mattresses, clothing, and other decorative articles, portable objects, and worn items, the said continuous large volumes of positive ions emitted directly to or near the body are absorbed by the body, effectively promoting blood circulation and enlivening cell activity. Or, the finely pulverized, rare earth element of the invention herein can be mounted to air conditioner output vanes or refrigerator circulation fans for distributing large volumes of positive ions released throughout the area of coverage, thereby effectively purifying and deodorizing the air.

However, the said drawings and detailed description only serve disclose the most preferred embodiments of the air purification and physiological metabolism promoting health material herein and shall not be construed as a limitation of the present invention; furthermore, all embellishments and modifications based on the spirit and scope of the invention herein shall be included under the protected patent claims of the present invention.

1. An air purification and physiological metabolism promoting health material, the features of which are that the finely pulverized, naturally radioactive rare earth element is in an exposed state and attached to the surface of a synthetic or natural base material.

2. An air purification and physiological metabolism promoting health material as claimed in claim 1 in which the said finely pulverized, naturally radioactive rare earth element is disposed onto the said base material through an interlaced, adhesive, or other means.

3. An air purification and physiological metabolism promoting health material as claimed in claim 1 in which the said base material of natural or synthetic construction is fabricated as a sheet or a board.

4. An air purification and physiological metabolism promoting health material as claimed in claim 1 in which the said finely pulverized, naturally radioactive rare earth element mineral is blended for use as single element or combination of two or more elements.
